(19) United States
(12) Patent Application Publication
(10) Pub. No.: US 2011/0289881 A1
(43) Pub. Date: Dec. 1, 2011

(54) Wooden Lattice girder for construction and method for production thereof

(76) Inventor: Artur Schwoerer, Senden (DE)

(21) Appl. No.: 13/206,543

(22) Filed: Aug. 10, 2011

Related U.S. Application Data
(63) Continuation of application No. 12/226,981, filed on Nov. 4, 2008.

(30) Foreign Application Priority Data
May 10, 2006 (DE) 10 2006 021 731.4

(51) Int. Cl. E04C 3/12; B27M 1/08

(52) U.S. Cl. 52/836; 144/363

(57) ABSTRACT

A wooden lattice girder 1 for construction comprises an upper chord 4 and a lower chord 5, connected to each other by struts 2, having tenons 7 at each ends thereof, wherein the tenons 7 at one end of the struts 2 are glued into mortises 9 on the upper chord 4, running in the longitudinal direction of the upper chord 4, and the tenons 7 at the other end of the struts 2 are glued into mortises 9 on the lower chord 5, running in the longitudinal direction of the lower chord 5. The lateral surfaces 12 of a respective mortise 9 running in the longitudinal direction thereof encompass an acute angle and the surfaces 10 of the tenon 7 glued to said lateral surfaces 12 of said mortise 9 encompass a corresponding acute angle. The mortises 9 are fashioned in the chords 4, 5 using a circular saw and accordingly define rectangular openings in the chords 4, 5 having square corners.

This application is a continuation of Ser. No. 12/226,981 filed Nov. 4, 2008 as the national stage of PCT/DE2007/000661 filed on Apr. 17, 2007 and claiming Paris convention priority of DE 10 2006 021 731.4 filed May 10, 2006 the entire disclosures of which are hereby incorporated by reference.

### BACKGROUND OF THE INVENTION

The present invention relates to a wooden lattice girder for construction is comprising an upper chord and a lower chord, connected to each other by struts, each having tenons at the ends thereof, wherein the tenons on one end of the struts are glued into mortises on the upper chord, running in the longitudinal direction of the upper chord, and the tenons on the other respective end of the struts are glued into mortises on the lower chord, running in the longitudinal direction of the lower chord. Such lattice girders are used, for example, as girders for the formwork in concrete structures, particularly of concrete ceilings and concrete walls.

Lattice girders of this type are known, e.g., from DE 18 07 956 B1 or DE 18 17 718 A1. In these lattice girders, the chords have mortises running in the longitudinal direction of the chords with the lateral surfaces of the mortises being aligned in parallel. As a rule, these mortises are made by milling. The tenons are carved from the ends of the struts. Since in the case of lattice girders of this type, the struts are usually positioned in an oblique way with respect to the chords, at an angle of about 45°, the basic shape of the tenons in their plane parallel to the longitudinal direction of the struts is triangular. In this case, the tenons are formed by making parallel cuts into the ends of the struts in said longitudinal direction. I.e., they also have lateral surfaces which are parallel to one another.

In gluing the tenons into the mortises wood glue is applied onto the lateral surfaces of the tenons and/or mortises. Since the tenons and the mortises are made to interlock with perfect fit in analogy to a tongue and groove joint, the glue is displaced from the lateral surfaces to the bottom of the tenons upon insertion of the tenons into the mortises. If the tolerance is too small, the amount of glue left on the lateral surfaces is insufficient to make sure that a permanently attached glued joint is achieved.

U.S. Pat. No. 3,452,501 discloses a wooden lattice girder for construction is comprising an upper chord and a lower chord which are connected to each other by struts. Here, the tenons each at the ends of the struts are glued into mortises on the upper chord, running in the longitudinal direction of the upper chord, and the tenons at the respective other end of the struts are glued into mortises on the lower chord, running in the longitudinal direction of the lower chord.

In one embodiment of the mortises, the length of the mortises is not matched to the dimensions of the tenons, but extends along the entire length of the chords. In another embodiment, the mortises are matched to the dimensions of the tenons. These mortises have a rhombic cross-section. The mortises which are not matched to the tenons have the disadvantage that dirt and/or water may penetrate into the mortises. The latter may result in premature dissolving of the glue. To overcome the above-noted problems, the mortises, e.g., may be made with a rhombic cross-section. However, these must be produced at great expense. Even when using a milling cutter the mortises with a rhombic cross-section would only be formable with great difficulty.

The object of the invention is to provide a lattice girder and a method for producing a lattice girder overcoming the disadvantages of the prior art, wherein, in particular, a permanently attached joint between the chords and the struts is achieved having a larger range of tolerances wherein the production of the lattice girder is to be simplified.

### SUMMARY OF THE INVENTION

This object is achieved by the lattice girder and the method of producing the latter according to the claims.

The wooden lattice girder according to the invention comprises an upper chord and a lower chord which are connected to each other by struts. Each strut has tenons at the ends thereof, with the tenons being glued at each end of the struts into mortises of the upper chord, running in the longitudinal direction of the upper chord, and the tenons at the respective other end of the struts are glued into mortises of the lower chord, running in the longitudinal direction of the lower chord. Herein the respective length of the mortises in the longitudinal direction of the chords at least largely corresponds to the dimensions of the tenon inserted and glued into the respective mortise, i.e. the mortises extend over a partial length of the chords only.

The lateral surfaces of a respective mortise running in the longitudinal direction encompass an acute angle and the surfaces of the tenon glued to said lateral surfaces of said mortise encompass a corresponding acute angle. The tenons are tapering by encompassing an acute angle from the lateral surfaces in the direction of their ends, and the width of the mortises perpendicular to the longitudinal direction of the chords reduces accordingly towards their respective mortise bottom.

According to the invention, the openings of the mortises, at the surface of the respective chord into which they are cut, are rectangular or substantially rectangular. In other words, these openings have square, rather than rounded corners. The square corners are the structural result of the fact that the mortises are cut into the chords using a circular saw blade. If the mortises were milled into the respective chords, the corners would not be square, rather rounded and exhibit a radius of curvature which corresponds to the diameter of the milling tool. Advantageously, the cross-sections of the tenons inserted into the mortises are also formed accordingly to achieve a perfect fit of the tenons in the mortises. Advantageously, if several tenons have been inserted into a mortise, the cross-section of the structure, which is formed by the tenons and inserted into the mortise, is formed accordingly in a matching rectangular manner.

Thus no glue applied to the lateral surfaces is displaced, or to a negligible extent only, towards the bottoms of the mortises upon insertion of the mortises. The glue remains adhered to the surfaces, whereby sufficient glue is kept in situ to provide for a permanently attached joint. Due to the fact that the mortises are formed in a length-adjusted manner, the tenons may fill and seal the volume of the mortises such that no soil may penetrate into the mortises. Due to the square corners of the mortises, the lattice girder according to the invention may be produced in a simple way since mortises of this type are easily produced using circular saw blades. In the process, at least two cuts with a circular saw with the cutting planes each being angled with respect to one another are made to form the mortise in a respective chord. Thus the lattice girder may be produced in a cost-effective and expeditious way.

If the ends of the struts each have two tenons, a construction having a superior load bearing capacity is achieved without causing excessive expenditure for forming the structures to be glued.

A clearance is preferably formed between the mortise bottom side end of the tenons and the mortise bottom of the mortise into which the respective tenon is glued. This clearance is capable of receiving the amount of glue being squeezed out by pressing the lateral surfaces of the tenons against the lateral surfaces of the mortises such that insertion of the tenons into the mortises is possible without a displacement resistance being caused due to the amounts of glue.

If each of the mortise bottoms of the mortises in the longitudinal direction of the chords have a semi-circular profile each, the mortises may be sequentially cut into the corresponding chord using a plurality of tilted saw blades.

Advantageously, two adjacent struts are each interlocked in the region of their ends being glued into mortises of one of the chords. This enables force to be transmitted from one strut to another. Thus, transverse loads may be borne far better by the inventive girder.

Preferably, the glued ends are interlocked with one another by means of a dovetail fine finishing of the abutting tenons. Due to the zigzag shape formed by dovetail fine finishing, a superior contact surface of the surfaces to be joined is achieved. A high degree of strength is obtained when contact surfaces formed in such a way are glued.

It is particularly preferred when each dovetailed end forms a semi-circular profile in the longitudinal direction of the chords. The corresponding edges of the adjacent struts positioned obliquely on top of one another in conjunction with the semi-circular profile have an ellipsoid shape. Interlocked ends or tenons, respectively, which are formed in such a way, may be positioned into accordingly formed mortises with perfect fit. Due to the semi-circular profile, the contact surfaces to be glued, namely, the lateral surfaces of the mortises and the associated lateral surfaces of the tenons, are maximized with respect to their surface area, resulting in a particularly durable bonding and thereby in particularly sturdy lattice girders.

In a further embodiment of the invention, the mortises in the chords have circular and/or oval-shaped partial areas when viewed in side elevation to which the corresponding dovetail shapes of the struts are matched.

To produce lattice girders according to the invention the tenons of the struts are glued into the mortises of the chords. To make the mortises, preferably by means of a circular saw blade, a first lateral surface of a mortise, running in the longitudinal direction of the chords, is formed by is making a first cut with a circular saw. Thereafter, the second lateral surface of this mortise running in the longitudinal direction of the chords is formed by making a second cut using a circular saw. The cutting planes of the circular saw cuts are set in accordance with the acute angle to be generated between the lateral surfaces of the mortise.

The invention will be described in detail hereinafter based upon an exemplary embodiment with reference to the drawings.

### BRIEF DESCRIPTION OF THE DRAWING

FIG. 1a shows a section of the lattice girder according to the invention;

FIG. 1b shows an exploded view of the section of the lattice girder of FIG. 1a according to the invention;

FIG. 2 shows a side view of the section of the lattice girder of FIG. 1 according to the invention;

FIG. 3 shows a strut of the lattice girder of FIGS. 1.

### DESCRIPTION OF THE PREFERRED EMBODIMENT

The figures of the drawings are showing the inventive subject matter in a highly diagrammatic fashion and are not to be understood as being to scale. The individual components of the inventive subject matter are illustrated such that their structure is readily shown.

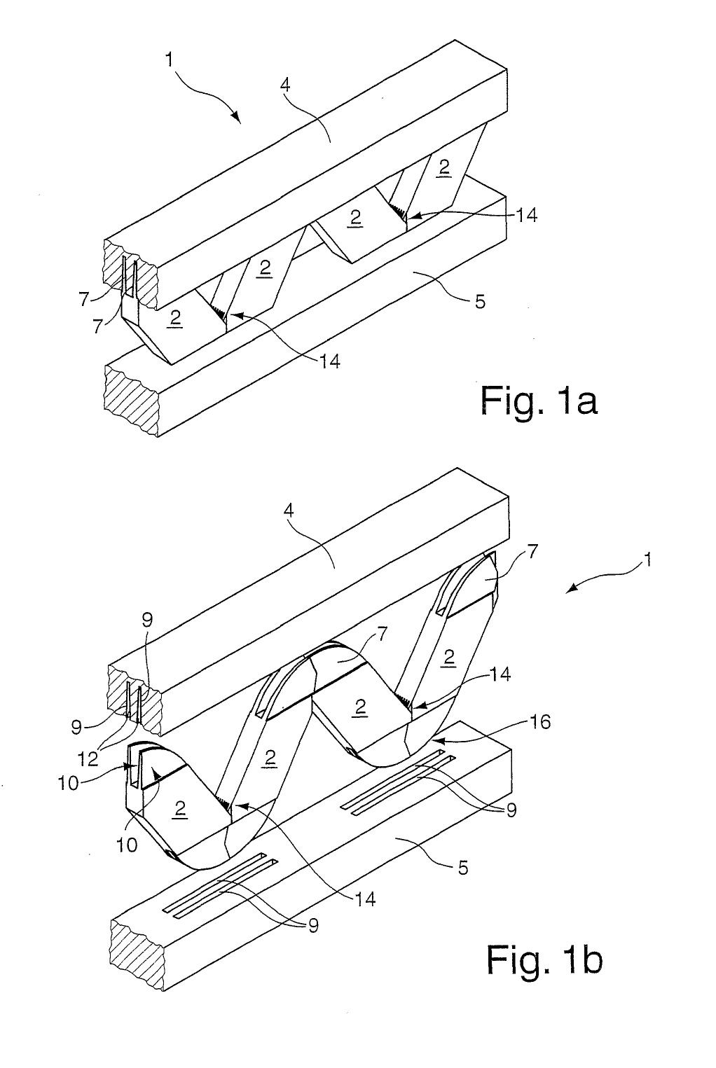

In the FIG. 1 a section of the lattice girder 1 according to the invention is illustrated. FIG. 1a shows the section in the assembled condition and FIG. 1b shows the section in an exploded condition.

The dimensions of the lattice girder 1 are comparable to those customary for lattice girders in the field of construction. The lattice girder 1 has a length of several meters, and the struts 2 and the chords 4, 5 thereof have a thickness of several centimeters. The lattice girder 1 comprises an upper chord 4 and a lower chord 5. Chords 4, 5 are connected to one another via struts 2. The struts 2 are positioned obliquely onto chords 4, 5, with the struts 2 encompassing an angle of about 45° in conjunction with chords 4, 5. The struts 2 have two tenons 7 each at the ends thereof. Chords 4, 5 have mortises 9 in the longitudinal direction thereof, with one mortise 9 each being associated with a tenon 7. In the assembled condition, each tenon 7 is glued into the associated mortise 9. I.e., the tenons 7 at one end of the struts 2 are each glued into mortises 9 of the upper chord 4, and the tenons 7 of the respective other end of the struts 2 are glued into the mortises 9 of the lower chord 5. The lateral surfaces 12 running in the longitudinal direction of a mortise 9 each encompass an acute angle and the surfaces 10 of the tenon 7 glued to said lateral surfaces 12 of the respective mortise 9 encompass a corresponding acute angle. Thus, the respective lateral surfaces 10, 12 of tenons 7 and/or mortises 9 are not aligned in parallel. Due to this the tenons 7 are tapering towards the ends thereof. Accordingly, the width of the mortises 9 perpendicularly to the longitudinal direction of the chords 4, 5 towards the bottom of the mortises is reduced due to the fact that an acute angle is encompassed. In the assembled condition the tenons 7 are glued with the respective lateral surfaces 10, 12 of the mortises 9 with closely matching fit. Two struts 2, each adjacent to another are interlocked in the region of the ends thereof which are glued into the mortises 9 of one of the chords 4, 5. For this purpose the ends of the struts 2 and the tenons 7 in their abutting regions have a dovetail fine finishing 14. This dovetail fine finishing 14 each consists of a zigzag profile, with the profiles of the regions adjacent to one another being formed in a complementary fashion such as to interlock fittingly so that the lateral surfaces of the tenons 7 and the struts 2 corresponding to each other, each travel in a plane. In the figures the zigzag profiles of the dovetail fine finishing 14 are recognizable in those regions adjacent to tenon 7 of the struts 2.

The mortise bottoms of mortises 9 each have a semi-circular profile in the longitudinal direction of the chords 4, 5. The ends of the struts 2, which are interlocked with one another, and/or the dovetailed tenons 7 in the longitudinal direction of the chords 4, 5 each form a respective semi-circular profile 16. I.e., an ellipsoidal shape is formed together with the associated edges of the struts 2. This enables the lateral surfaces 10 which are glued with one another to extend over a large area.

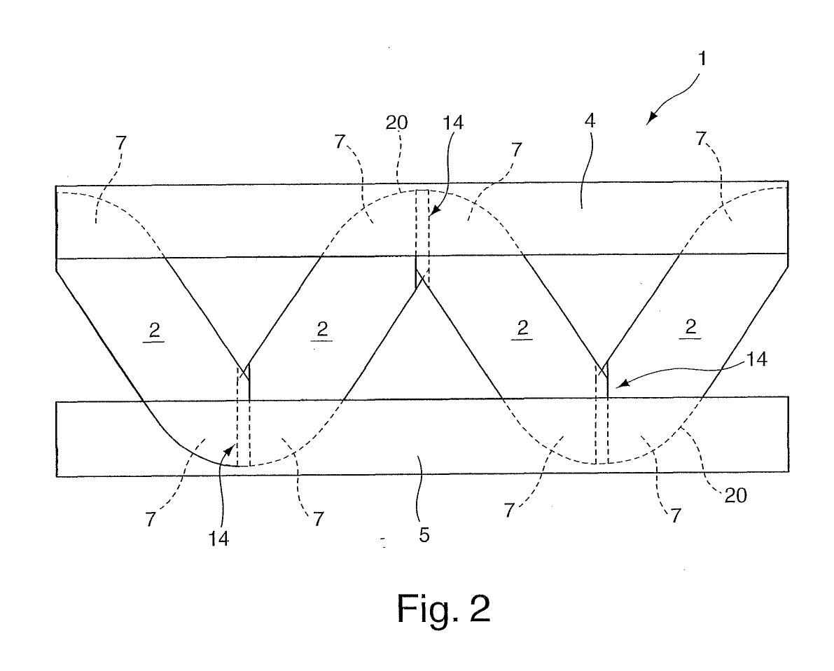

In FIG. 2 the section of the lattice girder according to the invention of FIG. 1 is illustrated in a side view. The dimensions of the tenons 7, positioned in the chords 4, 5 in a glued condition, are shown as dashed lines 20 having a semi-circular profile. The semi-circular profiles of the tenons 7 interlocked with one another and the bottoms of the mortises correspond to these dashed lines 20 (simplified illustration without clearance between the dovetails). Further, the dimension of the dovetail fine finishing 14 relative to the depth of the mutual engagement of the fine finish with the respective adjacent strut 2 is illustrated by two dashed lines, each running in parallel in the abutting regions of the adjacent struts.

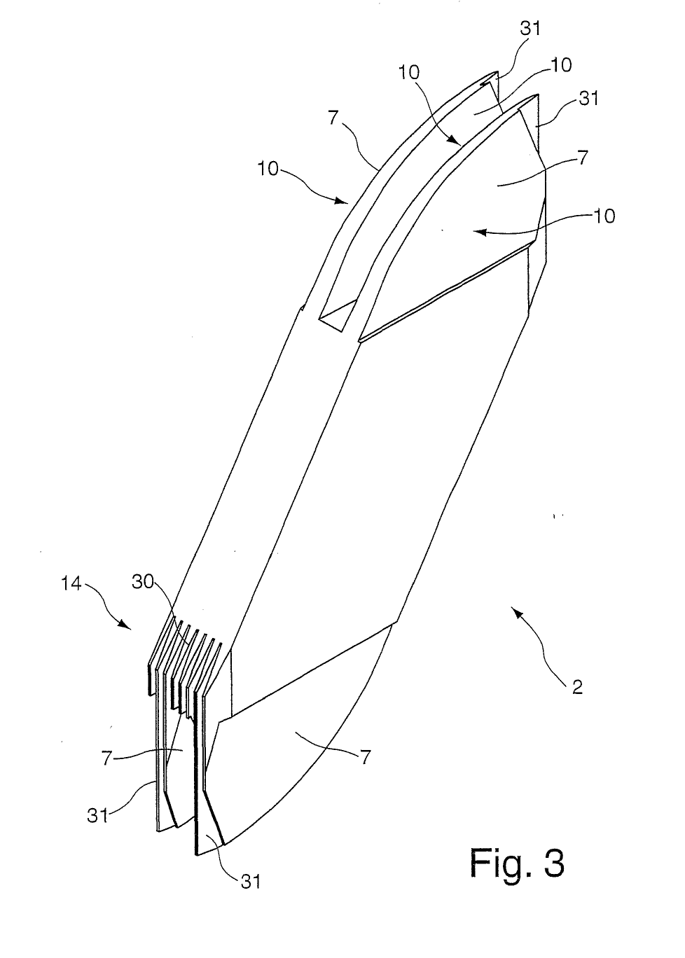

FIG. 3 shows an individual strut 2 of the lattice girder of the FIGS. 1. The tapering shape of the tenons 7 which is formed in that the respective lateral surface 10 of a tenon 7 each forms an acute angle, which is clearly discernible. The design of the dovetail fine finishing 14 proximate the regions abutting the adjacent strut of the ends of the strut 2 and the associated zigzag profile 30 are also illustrated. One dovetail 31 of a respective zigzag profile 30 of the end of the strut 2 extends over the entire length of each tenon 7.

The invention proposes a wooden lattice girder 1 for construction is comprising an upper chord 4 and a lower chord 5, connected to each other by struts 2, each having tenons 7 at the ends thereof, wherein the tenons 7 at one end of the struts 2 are glued into mortises 9 on the upper chord 4, running in the longitudinal direction of the upper chord 4 and the tenons 7 at the respective other end of the struts 2 are glued into mortises 9 on the lower chord 5, running in the longitudinal direction of the lower chord 5. The lateral surfaces 12 of a respective mortise 9 running in the longitudinal direction thereof subtend an acute angle and the surfaces 10 of the tenon 7 glued to the lateral surfaces 12 of the mortise 9 encompass a corresponding acute angle with respect to each other.

The invention is not restricted to the above-mentioned embodiments. Rather, a number of variants are conceivable which may make use of the features of the invention even if they have a basically different design.

I claim:

1. A wooden lattice girder for construction, the girder comprising:
an upper chord, said upper cord having upper cord mortises running in a longitudinal direction of said upper cord with lateral surfaces of said upper chord mortises running in longitudinal directions thereof subtending an upper acute angle, said upper chord mortises having, when viewed in side elevation, circular and/or oval-shaped upper chord partial areas;
a lower chord, said lower chord having lower chord mortises running in a longitudinal direction of said lower chord with lateral surfaces of said lower chord mortises running in longitudinal directions thereof subtending a lower acute angle, is said lower chord mortises having, when viewed in side elevation, circular and/or oval-shaped lower chord partial areas; and
struts connected between said upper chord and said lower chord, said struts having upper tenons at upper ends thereof, each of said upper tenons being inserted into and glued within a respective one of said upper mortises, wherein surfaces of said upper tenons glued to said lateral surfaces of said upper chord mortises encompass a corresponding said upper acute angle, said struts also having lower tenons at lower ends thereof, each of said lower tenons being inserted into and glued within a respective one of said lower mortises, wherein surfaces of said lower tenons glued to said lateral surfaces of said lower chord mortises encompass a corresponding said lower acute angle, said mortises thereby defining rectangular openings at a surface of a respective chord into which they are cut, said rectangular openings having square corners generated by a circular saw blade, wherein dovetail shapes of said struts are matched to said upper and said lower chord partial areas and lengths of said upper and lower chord mortises in said longitudinal direction of said upper and lower chords substantially correspond to dimensions of respective said upper and respective said lower tenons inserted therein.

2. The lattice girder of claim 1, wherein said upper ends of said struts each have two upper tenons and said lower ends of said struts each have two lower tenons.

3. The lattice girder of claim 1, wherein clearances obtain between bottoms of said upper and said lower chord mortises and respective adjacent ends of said upper and said lower tenons glued therein.

4. The lattice girder of claim 1, wherein bottoms of said upper and said lower chord mortises in said longitudinal direction of said upper and said lower chords each have a semi-circular profile.

5. The lattice girder of claim 1, wherein adjacent chord ends glued within cord mortises are interlocked to another.

6. The lattice girder of claim 5, wherein glued cord ends are interlocked with one another by means of a dovetail fine finishing in abutting tenons.

7. The lattice girder of claim 6, wherein dovetailed chord ends each form a respective semi-circular profile in said longitudinal direction of said upper and said lower chords.

8. A method for producing the lattice girder of claim 1, the method comprising the steps of:
a) using a circular saw blade and a circular saw to fashion a first cut within the upper or lower chord to form a first lateral surface of a respective mortise running in the longitudinal direction of that chord; and
b) using the circular saw blade and the circular saw to fashion a second cut within the upper or lower chord to form a second lateral surface of the respective mortise running in the longitudinal direction of the chord, wherein cutting planes of the first and the second cuts are set in accordance with the acute angle to be generated between the lateral surfaces of the respective mortise.

9. A lattice girder produced by the method of claim 8.
